(19) United States
(12) Patent Application Publication
(10) Pub. No.: US 2010/0037240 A1
(43) Pub. Date: Feb. 11, 2010

(54) Non Intrusive Application Mechanism

(75) Inventors: Benoit Launay, Seattle, WA (US); Torsten Stein, Bothell, WA (US); Michel Rotteleur, Bougival (FR); Patrice Manac'h, Maurecourt (FR); Michael Murphy, Tacoma, WA (US); Lee J. Zuckett, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/188,247

(22) Filed: Aug. 8, 2008

(51) Int. Cl. G06F 9/46

(52) U.S. Cl. 719/328

(57) ABSTRACT

An application integration mechanism may identify and use user interface controls to connect to an application. The integration mechanism may provide a programmatic environment for integrating data received and transmitted between different applications, as well as controlling the operation of the various applications. A general interface type may be defined for various applications and a metadata definition may be used by the interface type to bind specific controls to various identifiers such as friendly names. Within the integration mechanism, a set of automations may be defined to process data received from one application and transfer the processed data to another application with or without user interaction.

### BACKGROUND

Very few companies have a single, integrated line of business applications. In many cases, a company may have several different business applications that operate independently of each other. There are often instances where one user may use several different applications in a single job function, and where each of the applications may use the same or similar information.

For example, a call center employee may use two, three, or more different line of business applications when responding to a telephone inquiry from a potential customer. In many cases, information such as the customer name and address may be entered into multiple applications. Because the applications are separate and independent, the employee may enter the same information into several different applications in order to establish the callers as a customer, for example.

Many line of business applications may be legacy applications that have been used for many years and may operate on older operating systems or may not have advanced tools for integration with other applications.

### SUMMARY

An application integration mechanism may identify and use user interface controls to connect to an application. The integration mechanism may provide a programmatic environment for integrating data received and transmitted between different applications, as well as controlling the operation of the various applications. A general interface type may be defined for various applications and a metadata definition may be used by the interface type to bind specific controls to various identifiers such as friendly names. Within the integration mechanism, a set of automations or processes may be defined to process data received from one application and transfer the processed data to another application with or without user interaction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for integrating applications.

FIG. 2 is a flowchart illustration of an embodiment showing a method for creating metadata and processes.

FIG. 3 is a flowchart illustration of an embodiment showing a method for operating automated processes across applications.

### DETAILED DESCRIPTION

Applications may be integrated together by binding user interface controls to objects that may be manipulated using a programming environment. The user interface controls may supply or receive data, and some user interface controls may cause an application to perform a function or task.

An adapter may be used to connect an application and an integration framework. Adapters may be created for different types of applications and sets of metadata may be used to create bindings between a control and an identifier. The identifier may be used within the integration framework by various processes that may be automatically or manually invoked.

The applications may be integrated into a programming environment through an application's user interface. Each user interface may have controls that source data, consume data, and cause the application to perform actions, give status, or other functions. Different types of user interfaces may make various controls available to an adapter using different mechanisms. For each type of user interface, an adapter may be used to bind controls to identifiers within the programming environment. One or more metadata sets may be defined for each application, in which the specific controls and their identifiers and other metadata may be defined.

The architecture may enable simple and effective integration of different types of applications which may not be easily accomplished. A programmer or developer may create a metadata set that may enable data to be gathered or sent to the application as well as control the function of the application. The identifiers for the various controls may be manipulated within a programming environment without the complexities of integrating with the application itself.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

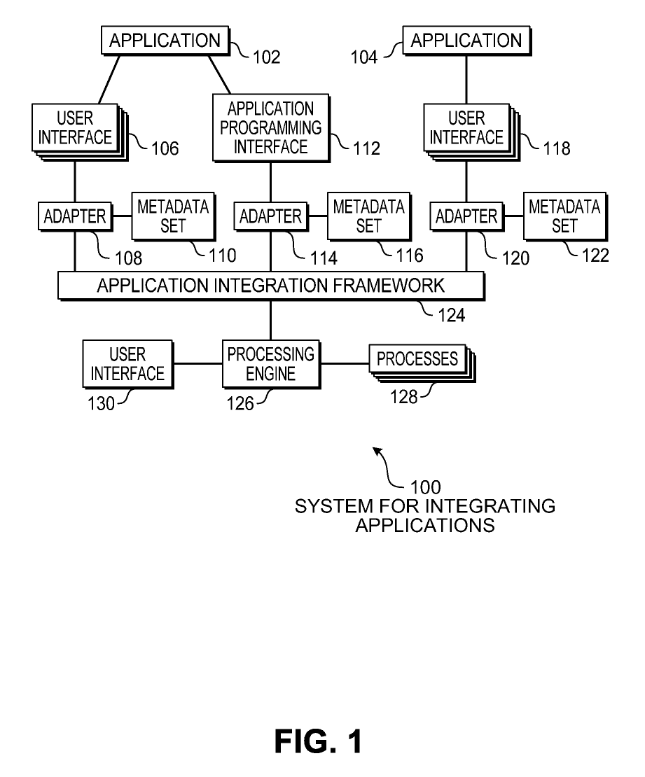

FIG. 1 is a diagram of an embodiment 100 showing a system for integrating applications. Embodiment 100 is a simplified example of an environment where various automation processes may be used to receive data from one or more applications, process the data, and distribute the data to other applications. The environment may enable a program or process to control various functions within the applications.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of an architecture that may be used to enable applications to interface with each other and otherwise be controlled using automated processes. In many cases, two or more very different and otherwise incompatible applications may share information, process information received from the other application, or perform other cooperative operations.

One example of a system of embodiment 100 may be a call center environment where a call center operator may use multiple applications to respond to a customer's call. For example, a call center operator may receive a call from a prospective customer. In order to take an order, the operator may enter the customer information into several different applications, such as an accounting application, an order processing application, and a company mailing list. In each of the three applications, the call center operate may enter the customer name, address, and other particulars. When the three applications are separate and distinct, the operator may enter the data three times, which consumes time and is prone to errors. When the three applications are integrated using embodiment 100, an automated process may consolidate the data entry by sharing the customer name, address, and other particulars between each of the applications.

Applications may have many different types of user interfaces. For example, some applications may operate natively on a device and may have a user interface generated by a locally running application. Other applications may use a web-based or HTTP-based user interface. Some newer applications may be developed using languages and tools that expose user interface controls, while other applications may have been developed with different technologies where the controls may not be readily available. In some cases, an application may have an application programming interface through which controls and other functions may be accessed.

An adapter may be created for different types of user interfaces. An adapter may contain routines, utilities, and other capabilities that may enable access to a user interface. An adapter may use a metadata set to define the interface between an application and an application integration framework so that processes within the application integration framework may interact with the application controls.

Embodiment 100 illustrates two applications 102 and 104. The applications 102 and 104 may be any application that has a user interface 106 and 1 18, respectively. Each user interface 106 and 118 may have an adapter 108 and 120, respectively, that may enable content from the respective user interface to be manipulated within the application integration framework 124.

Each user interface type may have several different controls. One type of control may be a data source. A data source may provide data to the user interface. Another type of control may be a data recipient, which may be a mechanism for receiving data from a user. An example of a data recipient may be a text box, list box, radio button, check box, or any other user input mechanism. In some embodiments, a user may interact with a user interface by drawing lines, moving icons, or performing other actions as well. Another type of control may cause an application to perform a specific task. An example may be a button that launches a function.

In some embodiments, a single control may perform several different roles. For example, a user interface may determine a value for a variable and display the value in a visible portion of a list box. In this manner, the list box may operate as a data source. A user may interact with the list box to select a different value. In this manner, the list box may operate as a data input mechanism. In some cases, the selection of a value in the list box may cause an application to evaluate the data in the list box. In such a case, the list box may serve to launch an application function.

Different embodiments may have different controls that operate in many different manners and provide various capabilities. Different types of adapters may have different mechanisms for defining and interacting with the controls available on a specific type of user interface.

Some adapters may read a description of a user interface and interact with controls defined in the user interface description. For example, an HTTP or HTML adapter may be capable of receiving an HTML document and identifying the various controls in HTML documents. A metadata set for such an adapter may identify the specific controls, assign a friendly name or other identifier to the control, and define other properties from which a binding may be created. In an HTML document, various controls may be identified by reading the HTML code. For example, information that is displayed may be presented with tags or other indicators. Form elements may have identifiers or tags that may identify different controls.

Some applications create a window or other user interface within an operating system environment. In such a user interface, different portions of the user interface may act as controls. An adapter for such a user interface may connect to the user interface in several different manners.

In one type of adapter, a user interface may be created by an application that may have been written using a specific set of development tools, such as a library of user interface routines. In such an embodiment, the library of user interface routines may expose user interface controls so that the controls are available for binding when defined in a metadata set.

In another type of adapter, a user interface may be created by an application for which the controls may not be exposed. In such a case, a metadata set may define a control based on the coordinates of various features, elements, or other controls presented to a user.

In still another type of adapter, a user interface may be created by an application that is created by a remote device and presented on a local device. Such technology includes various redirection technologies, remote desktop technologies, and other such mechanisms. Such an adapter may have tools or capabilities to intercept communications from the remote device and expose controls within the user interface.

The term ‘expose’ may include any type of mechanism whereby a user interface control may be accessed programmatically. In some cases, a service may operate in conjunction with a user interface and make various controls available for binding with the application integration framework 124.

The adapters 108 and 120 have a metadata set 110 and 122, respectively, in which the controls of the user interfaces 106 and 118 are made available to the application integration framework 124. The metadata sets may define each control in a manner useful to the application integration framework 124. In a typical embodiment, an adapter may provide tools or mechanisms capable of identifying and accessing a user interface control. An adapter may be a generic set of tools that may operate with a specific type of user interface. In a typical embodiment, an adapter may have functions, methods, data types, and other elements that are configured to work with a specific type of user interface. A metadata set may contain descriptions of available controls that may be described and accessed using the elements of an adapter.

In some embodiments, one metadata set may be created for a single application. In other embodiments, separate metadata sets may be created for individual user interfaces of an application. In still other embodiments, a metadata set may be defined that operates with two or more applications.

Some embodiments may use XML or other declarative language for some or all of a metadata set. In such embodiments, an adapter may be expressed as an XML assembly or another declarative language.

The application integration framework 124 may be a language or definition that may enable a processing engine 126 to execute various processes 128. The processes 128 may use controls defined by a metadata set and implemented by an adapter. For example, a process may receive data from one control on a first application, process the data, and send the processed data to another control on another application.

The processes 128 may perform integration tasks such as transferring data from one application to another. Because an application may be accessed through its existing user interface, very little, if any, programmatic access to the application is used. Such an architecture allows an application for which little, if any, programmatic interface to be integrated with other applications. For example, a legacy application written in an older language with little programmatic interfacing capabilities to be easily integrated with other applications. In another example, a remotely hosted web-based application may be likewise integrated without programmatic access.

In many applications, such as application 102, an application programming interface 112 may be available. In many embodiments, an adapter 114 may be used with a metadata set 116 to make various controls available to the application integration framework 124 through the application programming interface 112. In some such embodiments, the application programming interface 112 may expose additional functions or capabilities that may not be available through the user interface 106.

In some embodiments, an application 102 may be accessed through either or both of a user interface 106 or an application programming interface 112.

The processes 128 may be any type of automated action, and may use one or more controls from an application. In some cases, the processes 128 may be short scripts or functions that are launched or performed when a condition has been met.

For example, when a user updates a customer name control on the user interface 106, a process may be launched that receives the updated data, reformats the data to meet a customer name control for application 104, and transfers the data to a similar control on user interface 118.

In such an embodiment, a user may work with a user interface 106 to access an application 102. As the user interacts with the user interface 106, various processes 128 may monitor the interaction and may transfer data to one or more other applications 104. In such an embodiment, the user may not realize that the second application 104 is receiving data.

In some embodiments, the processes 128 may serve to aggregate two or more applications into a single user interface 130. For example, the processes 128 may be configured to define a user interface 130 for data input.

Using the example of a customer service representative above, the user interface 130 may be configured for customer data input. The user interface 130 may include a field for customer name. When the customer name is entered, the processes 128 may format or process the customer name information into forms compatible with corresponding customer name controls for user interface 106 and user interface 118, and may transfer the data to the respective controls. In such a manner, the user interface 130 may be used to integrate and aggregate applications 102 and 104.

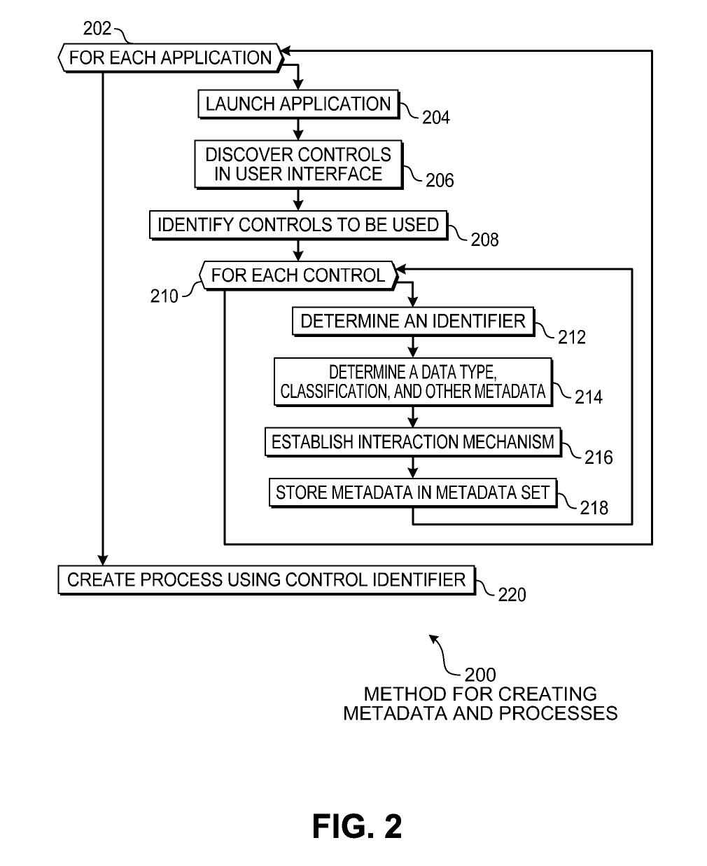

FIG. 2 is a flowchart illustration of an embodiment 200 showing a method for creating metadata and processes that may be used to integrate various applications. Embodiment 200 is a simplified example of some of the steps that may occur when integrating an application into a system such as embodiment 100. In some embodiments, various tools may automate or simplify one or more of the steps. In other embodiments, a programmer or developer may perform some of the steps manually.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is a simplified example of the steps that may be performed to create metadata for an adapter. In a typical use, a developer may identify a set of applications that are to be integrated. The applications may have some relationship to each other, such as the applications share some common data, or data supplied from one application may be used as an input to another application, for example.

Embodiment 200 illustrates a mechanism that may use some automated steps to assist a developer in discovering controls in a user interface. Other embodiments may not have such automated tools and a developer may perform discovery in a more manual manner.

For each application in block 202, the application may be launched in block 204. The controls in an application user interface may be discovered in block 206 and those controls to be used may be identified in block 208.

In some embodiments, a discovery tool may be used in block 206 to automatically scan a user interface and discover available controls in a running user interface. Such a tool may analyze the user interface directly, the underlying definition of the user interface, or use some other method.

For example, an automated discovery mechanism for block 206 may receive an HTTP document that may define a user interface for a web based application. In block 206, an automated tool may scan the HTTP document and identify one or more controls. A user may select the controls from a list in block 208.

In another example, an automated scanner may analyze an application user interface that is executing within an operating system environment. The application may be written in a language or using tools that may expose controls in a user interface, and those controls may be identified by an automated scanner and presented to a user for selecting in block 208.

In a manual example, a programmer or developer may manually analyze HTTP documents or a user interface to identify available controls.

For each control identified in block 208, the controls may be processed in block 210.

An identifier may be determined in block 212. The identifier may be a friendly name or some other reference that may be used within an application integration framework.

Various metadata may be determined in block 214, including a data type, classification, and other metadata. The control may be assigned a data type, such as a string, integer, real number, or other data type. In some cases, complex or custom data types may be used.

A control may have a classification or other parameters assigned in block 214. A classification may be any type of description of the function, purpose, or operation of a control. Each embodiment may have different classification system.

An interaction mechanism may be established in block 216. The interaction mechanism may be any method, process, service, or other mechanism by which the control may be accessed. In some cases, a service may monitor a control and create an alert or trigger when a control is changed. In such a case, the service may be the interaction mechanism.

In some cases, the interaction mechanism may be part of the capabilities of an adapter and such a mechanism may be implicitly selected in block 216. In other cases, the interaction mechanism may be separately defined and configured in block 216.

The metadata may be stored in a metadata set in block 218, and the process may return to block 210 to process the next control. Once all the controls are processed for a given application, the process may return to block 202 to process additional applications.

After identifying and configuring the various controls, a process may be created in block 220. The process created in block 220 may use any type of language, scripting, or process definition. The process created in block 220 may perform various manipulations of the controls defined in block 210.

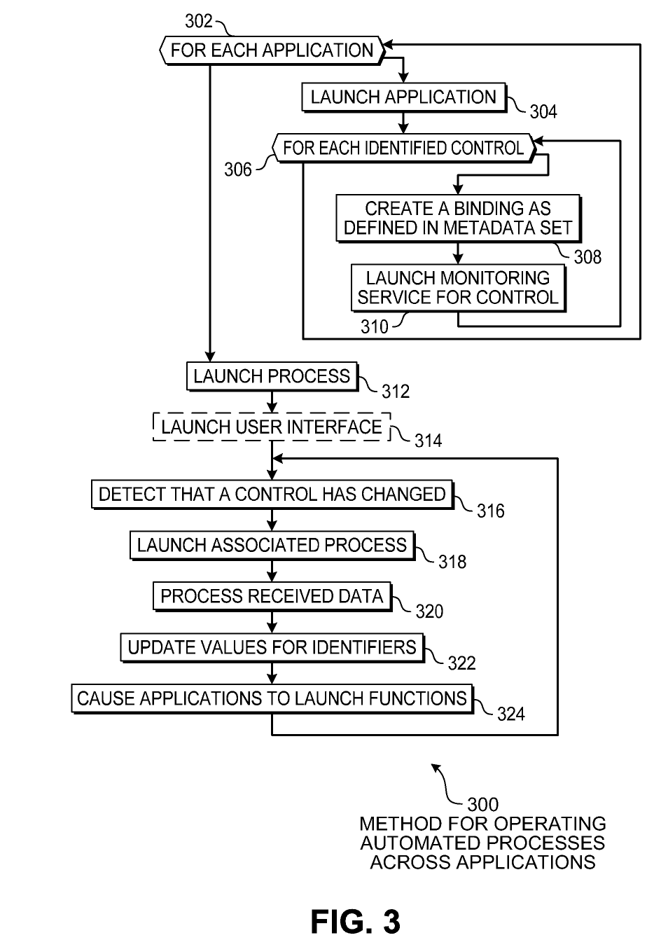

FIG. 3 is a flowchart illustration of an embodiment 300 showing a method for operating automated processes across multiple applications. Embodiment 300 is a simplified example of a method for executing the processes defined in embodiment 200 using the various controls.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

For each application in block 302, the application may be launched in block 304. In some embodiments, an application may not be caused to launch but a connection to an application may be established. In block 304, a user interface may be displayed for the application.

In some embodiments, the application launch in block 304 may redirect the user interface to an adapter that may provide an automated or programmatic connection to the user interface. The connection may be available within an application integration framework and accessed by processes operating within the application integration framework.

For each identified control in block 306, a binding may be created in block 308. The controls identified in block 306 may be those controls defined in a metadata set. In many cases, a subset of the available controls may be defined in the metadata set.

The metadata set may include enough information so that a binding may be created in block 308. A binding may establish a connection between a control and the control's identifier within an application integration framework. The binding may transfer a change from the control in the application to the identifier established by the metadata, and vice versa.

In some embodiments, a service may be launched in block 310 to monitor one or more controls. The monitoring service in block 310 may perform the function of a binding by updating and changes in the control or the identifier within an application integration framework.

After launching the applications and establishing bindings for each application in block 302, a process may be launched in block 312. The process in block 312 may operate within an application integration framework. In some cases, the process may launch a user interface in block 314.

During the process operation, a control may be changed and the change detected in block 316. The change may trigger an associated process to be launched in block 318.

The process launched in block 318 may process received data in block 320 and may update values for identifiers in block 322. Because bindings exist between application user interface controls and identifiers in an application integration framework, data may be received by a process when a control is updated or changed. Similarly, when an identifier within the application integration framework is updated, the changes may be transferred to the bound to controls in one or more of the applications.

In some cases, controls and their bound identifiers may be used to cause an application to perform various functions in block 324.

Embodiment 300 may return to block 316.

Embodiment 300 is a simplified example of creating bindings to application user interface controls and using those bindings to receive data from an application, push data to the same or a different application, and cause an application to perform a function. In many embodiments, this technology may be used to develop very complex processes that may share data between applications, process data received from different applications, and effectively control and operate disparate applications in a harmonious manner.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
connecting to a first application user interface using a first adapter;
identifying a first control on said first application user interface;
creating a first binding to bind said first control to a first identifier, said first binding being defined in a first metadata set for said first application user interface;
connecting to a second application user interface using a second adapter;
identifying a second control on said second application user interface;
creating a second binding to bind said second control to a second identifier, said second binding being defined in a second metadata set for said second application user interface; and
executing a process configured to receive a first value bound to said first identifier, process said first value to determine a second value, and transfer said second value to said second identifier, said second binding configured to transfer said second value to said second control.

2. The method of claim 1 further comprising:
identifying a third control on said second application user interface, said third control being configured to cause a function to be executed on said second application user interface;
creating a third binding to bind said third control to a third identifier, said third binding being defined in said second metadata set for said second application user interface; and
said process further configured to cause said function to be executed by said third binding.

3. The method of claim 1, said first application user interface being a web based user interface.

4. The method of claim 1, said second application user interface being a user interface for an application executing in an operating system environment.

5. The method of claim 1, said second application user interface being a user interface for an application have operable elements within an HTTP document.

6. The method of claim 5, said operable elements being referenced in a script within said HTTP document.

7. The method of claim 1, said first control being a data source.

8. The method of claim 1, said first control being identified by detecting an exposed user interface element.

9. The method of claim 1, said first binding comprising connecting to a service configured to create a notification when said first control changes.

10. A system comprising:
a first adapter configured to interface to a first type of user interface;
a first metadata set defining a first identifier for a first control in a first instance of said user interface;
a first binding between said first control and said first identifier, said binding being defined in said first metadata set;
a second metadata set defining a second identifier for a second control in a second instance of said first type of user interface;
a second binding between said second control and said second identifier, said binding being defined using said second metadata set; and
a processing engine configured to receive a predefined process and manipulate said first identifier and said second identifier.

11. The system of claim 10, said first control being a data source.

12. The system of claim 10, said first control being a data receptor.

13. The system of claim 10, said first control being a function control.

14. The system of claim 10, said first metadata set being defined for a first instance of said user interface for a first application.

15. The system of claim 10 further comprising:
a monitoring service configured to detect a change to said first control and updating said first binding based on said change.

16. The system of claim 10 further comprising:
a second adapter configured to interface to a second type of user interface;
a third metadata set defining a third identifier for a third control in a first instance of said second type of user interface; and
a third binding between said third control and said third identifier, said third binding being defined using said third metadata set.

17. A method comprising:
creating a first binding between a first identifier and a first control of a first user interface, said first user interface being a user interface created by a first application, said first binding being defined in a first metadata set and being implemented by a first adapter;
creating a second binding between a second identifier and a second control of a second user interface, said second user interface being a user interface created by a second application, said second binding being defined in a second metadata set and being implemented by a second adapter;
receiving a first data value from said first application through said first binding;
determining a second data value; and
transmitting said second data value to said second application through said second binding.

18. The method of claim 17 further comprising:
creating a third binding between a third identifier and a third control of said second user interface, said third binding being defined in said second metadata set and being implemented by said second adapter, said third control being configured to cause said second application to perform a function; and
causing said second application to perform said function through said third identifier.

19. The method of claim 17 further comprising:
creating a third binding between a third identifier and a third control of a first application programming interface, said third binding being defined in a third metadata set and being implemented by a third adapter.

20. The method of claim 17, said first control being present in at least two instances of said first user interface.
